(19) United States
(12) Patent Application Publication
(10) Pub. No.: US 2014/0071396 A1
(43) Pub. Date: Mar. 13, 2014

(54) EYEGLASSES

(71) Applicant: HSIN-HUNG KUO, TAINAN CITY (TW)

(72) Inventor: HSIN-HUNG KUO, TAINAN CITY (TW)

(21) Appl. No.: 13/613,092

(22) Filed: Sep. 13, 2012

(51) Int. Cl. G02C 5/22

(52) U.S. Cl. 351/121

(57) ABSTRACT

A pair of eyeglasses comprises two temples and a frame. Each temple is provided with a protrusion. Each end of the frame is defined with a notch, an elastic stopping piece protruded out of an inner wall of the notch, and a space formed between the stopping piece and the notch and provided for receiving the protrusion. The protrusion of the temple is located in the space by the elasticity of the stopping piece after pushing the stopping piece. And the elasticity of the stopping piece makes it restored and abutted against the protrusion, so as to prevent the protrusion from disengaging from the space. In addition, the temple can be pivoted to the frame without using bolts, which makes it easier to assemble and detach.

### BACKGROUND OF THE INVENTION

1. Field of the Invention

The present invention relates to a pair of eyeglasses, and more particularly to a pair of eyeglasses which can be assembled and detached quickly without using bolts.

2. Description of the Prior Art

A conventional pair of eyeglasses usually comprises a frame, two lenses engaged in the frame, and two temples pivoted to two lateral sides of the frame. At a pivot of the frame and each temple is provided a bolt. When not in use, the temples can be folded inwardly. However, the frame is connected to the temples by the bolts, so it is difficult to assemble and the bolts are liable to be lost after being detached.

The present invention has arisen to mitigate and/or obviate the afore-described disadvantages.

### SUMMARY OF THE INVENTION

The primary objective of the present invention is to provide a pair of eyeglasses which comprises two temples and a frame.

Each temple is provided with a protrusion and a pivot portion disposed at the protrusion.

Each end of the frame is defined with a notch, a pivot hole in communication with the notch and pivoted to the pivot portion, an elastic stopping piece protruded out of an inner wall of the notch, and a space formed between the stopping piece and the notch and provided for receiving the protrusion.

The protrusion of the temple is located in the space by the elasticity of the stopping piece after pushing the stopping piece. And the elasticity of the stopping piece makes it restored and abutted against the protrusion, so as to prevent the protrusion from disengaging from the space. In addition, the temple can be pivoted to the frame without using bolts, which makes it easier to assemble and detach.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a pair of eyeglasses in accordance with the present invention;

FIG. 2 is a partial exploded view of the pair of eyeglasses in accordance with the present invention showing the position of a temple relative to a frame;

FIG. 3 is a partial assembly cross sectional view of the pair of eyeglasses in accordance with the present invention showing the initial condition of a protrusion being located in a space and pushes a stopping piece; and

FIG. 4 is another partial assembly cross sectional view of the pair of eyeglasses in accordance with the present invention showing the protrusion after being located in the space completely and the stopping piece restored and abutted against the protrusion.

### DETAILED DESCRIPTION OF THE PREFERRED EMBODIMENTS

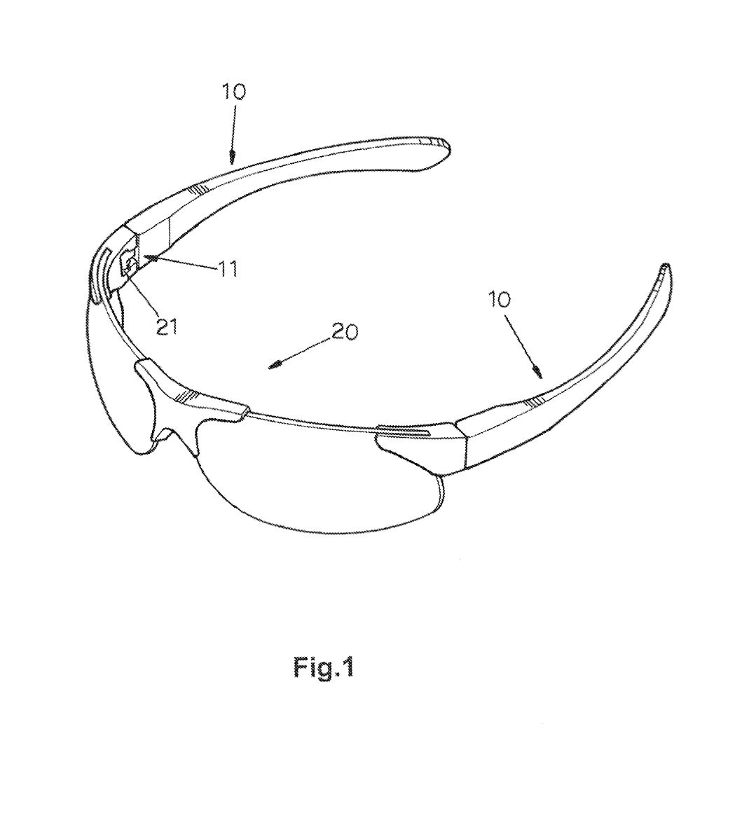

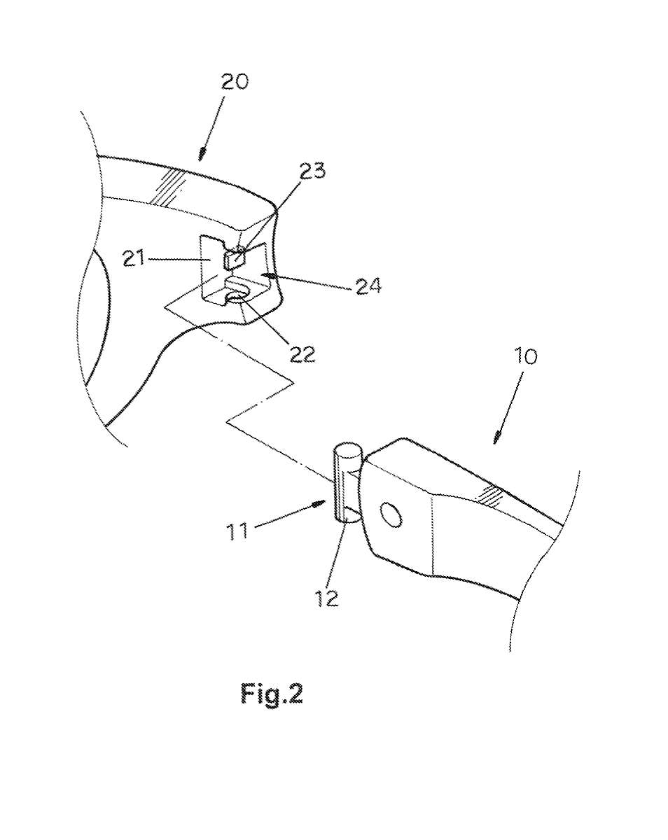

Referring to FIGS. 1 and 2, a pair of eyeglasses in accordance with the present invention comprises two temples 10 and a frame 20.

Each temple 10 is provided with a protrusion 11 and a pivot portion 12 disposed at the protrusion 11.

Each end of the frame 20 is defined with a notch 21, a pivot hole 22 in communication with the notch 21 and pivoted to the pivot portion 12, an elastic stopping piece 23 protruded out of an inner wall of the notch 21, and a space 24 formed between the stopping piece 23 and the notch 21.

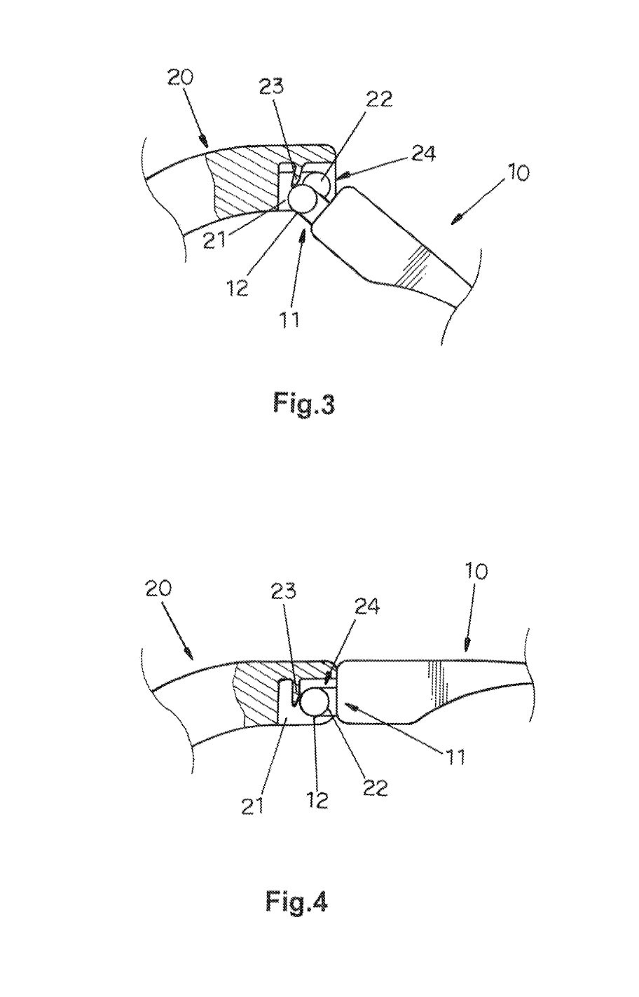

Referring to FIGS. 3 and 4, during the assembly process, the user combines the protrusion 11 of the temple 10 with the notch 21 of the frame 20, and presses the protrusion 11 to make it push the stopping piece 23, which enables the protrusion 11 to locate in the space 24 by the elasticity of the stopping piece 23. At that time, the stopping piece 23 will be restored and abutted against the protrusion 11 by its elasticity, so as to prevent the protrusion 11 from disengaging from the space 24. And then, the user pivots the pivot portion 12 to the pivot hole 22 and the temple 10 to the frame 20, such that the protrusion 11 can swing in the space 24, and the angle of the temple 10 relative to the frame 20 can be adjusted.

The temple 10 can be detached from the frame 20 by reversely operating the above-mentioned assembly steps, which is convenient to assemble and detach.

To summarize, the present invention is characterized in that: the protrusion 11 of the temple 10 is firstly inserted in the notch 21, and then is located in the space 24 by the elasticity of the stopping piece 23. And the elasticity of the stopping piece 23 makes it restored and abutted against the protrusion 11, so as to prevent the protrusion 11 from disengaging from the space 24. In addition, the temple 10 can be pivoted to the frame 20 without using bolts, which makes it easier to assemble and detach.

While we have shown and described various embodiments in accordance with the present invention, it should be clear to those skilled in the art that further embodiments may be made without departing from the scope of the present invention.

What is claimed is:

1. A pair of eyeglasses comprising:
two temples each being provided with a protrusion; and
a frame including two ends, each end of the frame being defined with a notch, an elastic stopping piece protruded out of an inner wall of the notch, and a space formed between the stopping piece and the notch and provided for receiving the protrusion.

2. The pair of eyeglasses as claimed in claim 1, wherein the respective temple is further provided with a pivot portion disposed at the protrusion, each end of the frame is further defined with a pivot hole in communication with the notch and pivoted to the pivot portion.
